(19) United States
(12) Patent Application Publication
(10) Pub. No.: US 2013/0075538 A1
(43) Pub. Date: Mar. 28, 2013

(54) Transport Aircraft Hull Attachment System

(71) Applicant: Wipaire, Inc., South St. Paul, MN (US)

(72) Inventor: Robert D. Wiplinger, Inver Grove Heights, MN (US)

(73) Assignee: WIPAIRE, INC., South St. Paul, MN (US)

(21) Appl. No.: 13/626,036

(22) Filed: Sep. 25, 2012

Related U.S. Application Data
(60) Provisional application No. 61/540,282, filed on Sep. 28, 2011.

(51) Int. Cl. B64C 25/66; B64C 3/54; B64C 25/54

(52) U.S. Cl. 244/218; 244/105; 244/102 R; 244/136

(57) ABSTRACT

An aircraft hull attachment device may be configured for attachment to a fuselage of an aircraft. The aircraft hull attachment device can include one or more floats to enable the aircraft to operate on water. The aircraft hull attachment device can also include a structure such as, for example, a saddle-shaped structure, for mounting the device against a bottom region of a fuselage of the aircraft. Upon being operatively coupled to the aircraft, the aircraft hull attachment device can convert an aircraft previously configured to operate only on ground landing strips into an aircraft configured to operate on water landing strips. Additionally or alternatively, the device can include a water tank and a water-tank door to enable the aircraft to which the device is mounted to perform in-flight water drops (e.g., during fire fighting aerial operations).

### RELATED APPLICATION

This U.S. patent application claims priority to U.S. Provisional Patent Application No. 61/540,282, filed on Sep. 28, 2011, the contents of which are hereby incorporated by reference.

### TECHNICAL FIELD

This disclosure relates to aircraft and, more particularly, to an attachment for aircraft that enable the aircraft to operate on water.

### BACKGROUND

Floatplanes and flying boats provide alternatives to land-based aircraft, which require a ground landing strip to takeoff and land. Floatplanes typically include one or more floats mounted under the aircraft to provide buoyancy to the aircraft when operating on water. Flying boats have a hull that enables water take offs and landings. In some designs, a floatplane also includes wheels to enable the aircraft to operate on a ground landing strip in addition to operating on water. Such floatplanes are referred to as amphibious aircraft because of their ability to operate on both land and water.

Many common aircraft types are, of course, designed only to take off from and land on ground landing strips. As just one example, many transport aircraft (e.g., “commuter aircraft”) of the type having two wing-mounted engines (e.g., twin-engine turbine powered transport aircraft) are built with fuselage-mounted landing gear. It would be desirable to provide these and other land-based aircraft with a system that enables them to operate on water.

It would be particularly desirable to provide an attachment device for a land-based aircraft that offers one or more of the following advantages: 1) the attachment device includes one or more floats, 2) the attachment device can be attached to the aircraft fuselage with little or no airframe reinforcement, 3) the attachment device makes the aircraft amphibious, 4) the attachment device enables the aircraft to operate on water without wing floats, 5) the attachment device generates lift for the aircraft during flight, 6) the attachment device prevents water spray from getting into propellers/engines of the aircraft during take-offs and landings, 7) the attachment device includes a water tank and a water-drop door to enable the aircraft to participate in fire fighting operations.

### SUMMARY

In general, the present disclosure is directed to an aircraft hull attachment device that can be removably attached to the fuselage of an aircraft. The aircraft hull attachment device can include a structure such as, for example, a saddle-shaped structure, for mounting the device against a bottom region (e.g., a belly) of the aircraft's fuselage. The aircraft hull attachment device includes one or more floats to enable the aircraft to takeoff from and land on water. In some embodiments, the aircraft hull attachment device also includes a water tank and a water-drop door. In such embodiments, the device once operably coupled to an aircraft can enable the aircraft to perform water-based aerial operations (e.g., dropping water from the aircraft while in flight). The device can optionally include one or more scoops such that the aircraft can fill the device's water tank as the aircraft moves across a body of water (e.g., in a scooping run) and then transport the water for aerial dispersion over a fire or another intended target area.

Thus, the aircraft hull attachment device may convert (e.g., retrofit) an aircraft designed solely to takeoff from and land on a ground landing strip into an aircraft this is capable of landing on water (in some cases, the resulting aircraft may be amphibious, i.e., capable of safely landing on/taking off from either water or land). In some applications, the attachment device can be installed so as to convert the aircraft into a water-capable aircraft without requiring further structural modifications to the aircraft (e.g., without reinforcement to the aircraft's airframe). The attachment device, for example, may in some cases be attached to the fuselage of an aircraft without having to add additional structural support members within the fuselage of the aircraft.

Additionally or alternatively, the aircraft hull attachment device in accordance with any of the foregoing embodiments may be attached to the aircraft's fuselage and can optionally be configured to provide sufficient lateral stability to the aircraft (e.g., when operating on water) that wing floats are not required to be provided on the main wings of the aircraft. Thus, depending on the configuration of the aircraft hull attachment device, the device may lend itself to being attached to the fuselage of an aircraft with minimal modifications to the aircraft.

In some embodiments of the present invention, an aircraft hull attachment device configured for attachment to a fuselage of an aircraft is provided. In certain embodiments of this nature, the device has two laterally spaced-apart floats for enabling the aircraft to takeoff from and land on water, and the device has a saddle wall configured to nest about (e.g., embrace) a belly of the fuselage such that when the device is mounted operably on the fuselage, a base region of the saddle wall is carried against a bottom region of the fuselage while confronting side regions of the saddle wall are carried against opposed sidewalls of the fuselage. The floats can optionally have the buoyancy characteristics and/or configuration/dimensions described in more detail below. In the present embodiments, the device can optionally have a water tank and a water-drop door. When provided, the water tank may be connected to a scoop adapted for filling the water tank during scooping runs of the aircraft on which the device is operably mounted. The device in accordance with the present embodiments can optionally have two opposed wings extending outwardly away from the floats. When provided, the wings of the device can optionally have the functionality/configuration described in more detail below.

Some embodiments of the invention provide an aircraft hull attachment device configured for attachment to a fuselage of an aircraft, where the device has two laterally spaced-apart floats for enabling the aircraft to takeoff from and land on water, and the device also has two opposed wings extending outwardly away from the floats. The floats can optionally have the buoyancy characteristics and/or configuration/dimensions described in more detail below. Preferably, when the device is mounted operably on the fuselage of the aircraft, the wings of the device are substantially parallel to main wings of the aircraft. In these embodiments, the wings of the device can optionally serve as sponsons, which laterally stabilize the aircraft when floating on a body of water. Thus, the main wings of the aircraft may be devoid of wing floats. Additionally or alternatively, the aircraft can have propellers and the wings of the device can be configured to shield (e.g., prevent) water spray emanating from the floats (during landings and take-offs) from reaching propellers of the aircraft. The configuration of the device preferably is such that it serves as a lifting body during flight, thereby lowering stall speeds for improved water operations. In the present embodiments, the device can optionally have a water tank and a water-drop door. When provided, the water tank may be connected to a scoop adapted for filling the water tank during scooping runs of the aircraft. The device in the present embodiments can optionally include a saddle wall configured to nest about a belly of the fuselage such that when the device is mounted operably on the fuselage, a base region of the saddle wall is carried against a bottom region of the fuselage while confronting side regions of the saddle wall are carried against opposed sidewalls of the fuselage.

The details of one or more examples/embodiments are set forth in the accompanying drawings and the description below. Other features, objects, and advantages will be apparent from the description and drawings, and from the claims.

### BRIEF DESCRIPTION OF DRAWINGS

FIGS. 1-3 are different schematic views of a system that includes an example aircraft hull attachment device attached to an example aircraft.

FIGS. 4-7 are different perspective views of the example aircraft hull attachment device of FIGS. 1-3 shown separated from the example aircraft of FIGS. 1-3.

FIG. 8 is a cross-sectional illustration of an example aircraft hull attachment device.

FIG. 9 is a bottom view of the example aircraft hull attachment device of FIG. 8.

### DETAILED DESCRIPTION

The following detailed description is to be read with reference to the drawings, in which like elements in different drawings have like reference numerals. The drawings, which are not necessarily to scale, depict selected examples and are not intended to limit the scope of the invention. Skilled artisans will recognize that the given examples have many useful alternatives, which fall within the scope of the claims.

Aircraft are generally configured to operate either from ground landing strips or water landing strips (e.g., lakes, rivers, or the ocean) during takeoff and landing operations. In the case of amphibious aircraft, which include both floatation equipment and ground landing equipment, the aircraft can operate from both ground landing strips and water landing strips at the option of the operator. Such an aircraft provides increased flexibility because the aircraft is not confined to ground landing strips. It is, of course, not safe to land on water with an aircraft designed only for ground landings.

The present disclosure describes devices, systems, and techniques for converting a land-based aircraft into an aircraft capable of operating on water. In one example, an aircraft hull attachment device configured for attachment to the fuselage of an aircraft includes (e.g., defines) one or more floats to enable the aircraft to operate on water. The aircraft hull attachment device preferably includes a mounting structure such as, for example, a saddle-shaped structure, for mounting the device against (e.g., so as to embrace) a bottom region (e.g., a belly) of the aircraft's fuselage. Upon being operatively coupled to the aircraft, the aircraft hull attachment device can convert an aircraft previously configured to operate only on ground landing strips into an aircraft configured to operate on water landing strips (the resulting aircraft may be amphibious, i.e., capable of operating on water or land).

Depending on the configuration of the aircraft hull attachment device, the device may include one or more of a variety of features for enhancing operation. In certain embodiments, the aircraft hull attachment device includes a water tank and a water-drop door. In addition, the aircraft can optionally be equipped with a scoop system, e.g., such that the water tank can be filled by flying low over a body of water in a scooping run. The aircraft can then fly to a fire being fought and the water in the tank released via the water-drop door. The water tank, of course, may also be filled before take off using a conventional water supply. Moreover, if the device is amphibious (e.g., has both floats for water landings and landing gear for ground landings), then the resulting aircraft can be used as either a land-based water bomber or a scooper-type aircraft.

In some embodiments, the aircraft hull attachment device includes opposed wings that extend outwardly from floats of the device. When provided, the wings of the device can optionally be configured to generate lift for the aircraft during flight. This may reduce the stall speed of the aircraft (as compared to when the device is not mounted on the aircraft). It may also reduce the stress on the main wings of the aircraft. Both compliment conversion of the aircraft for water operation. When provided, the wings of the device may (additionally or alternatively) provide lateral stability to the aircraft when floating on a body of water. Thus, the wings of the device may serve as a sponson. The resulting lateral stability may enable the aircraft to operate on water without requiring the main wings of the aircraft to have lateral stability devices (e.g., wing floats). Thus, certain embodiments provide an aircraft (to which the present device is mounted operably) where the main wings of the aircraft do not have (i.e., are devoid of) wing floats. When provided, the wings of the device can optionally serve other purposes. More will be said of this later.

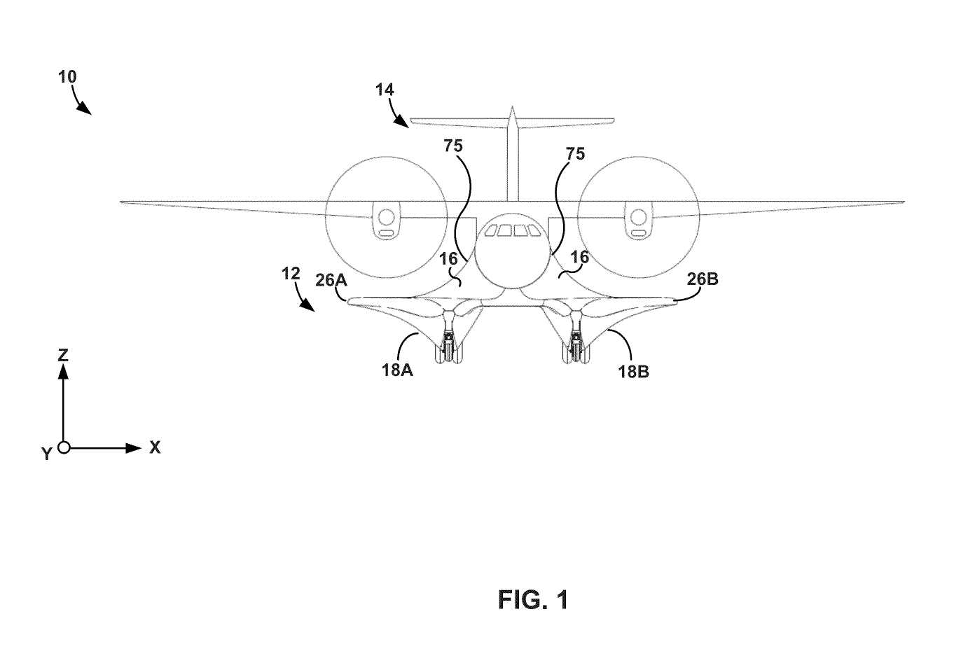

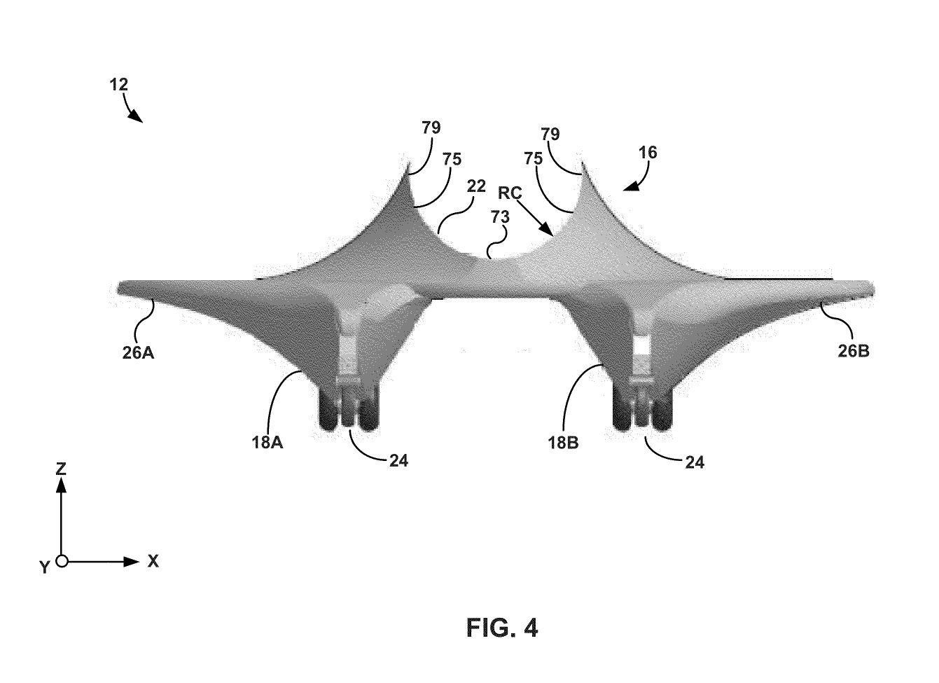

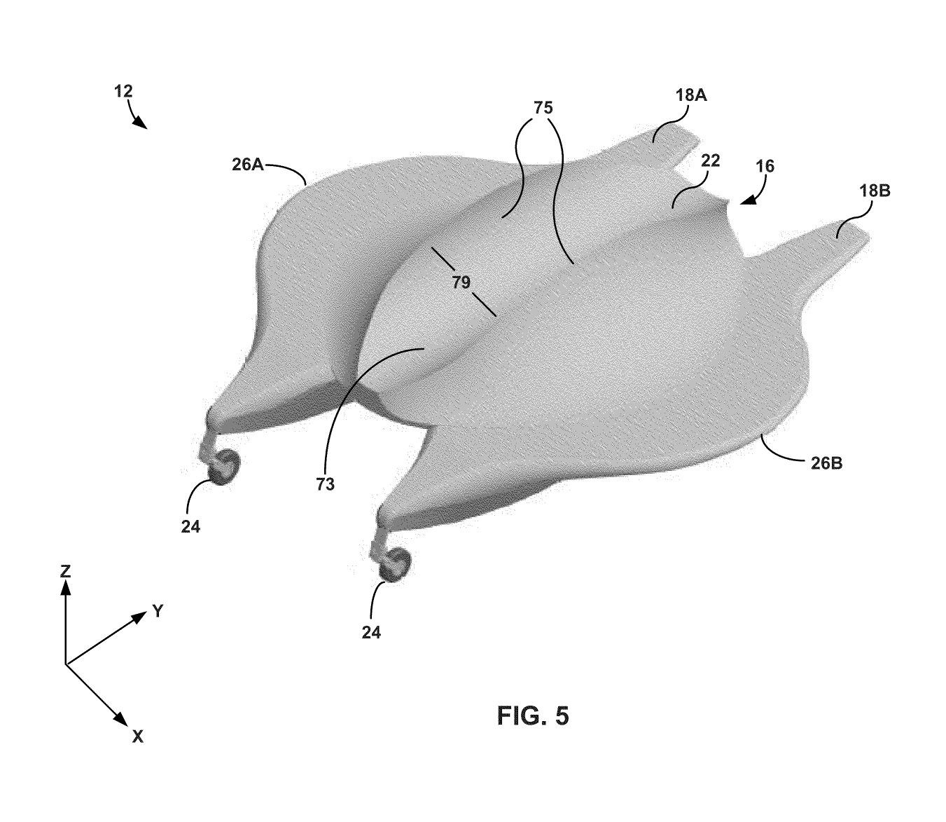

Different views of an example aircraft hull attachment device will be described in greater detail below with reference to FIGS. 4-7. First, though, FIGS. 1-3 will be described with respect to an example system wherein an example aircraft hull attachment device is attached to an example aircraft.

FIGS. 1-3 are different schematic views of a system 10 that includes an example aircraft hull attachment device 12 (also referred to herein as “the device” or “device 12”) attached to an example aircraft 14. Device 12 includes a mounting structure 16 that is configured to mate with (e.g., so as to embrace) the fuselage of the aircraft. Device 12 also includes at least one float 18. In the example shown in FIGS. 1-3, two floats 18A and 18B (collectively “floats 18”) provide buoyancy to the device 12 and the aircraft 14 when operating on water. Device 12 can be attached to the aircraft 14 by positioning the device's mounting structure 16 on the aircraft's fuselage, optionally such that part of the mounting structure 16 extends upwardly along at least a portion of the sidewalls of the fuselage. The mounting structure 16 can then be secured (e.g., mechanically attached and optionally electrically coupled) to the aircraft 14 to render the system operable. Once attached, the device 12 provides sufficient buoyancy and stability to enable the aircraft 14 to takeoff from and land on water, thereby converting an aircraft configured to operate only on land into an aircraft configured to operate on water. In some cases, the converted aircraft is amphibious. More will be said of this later.

As described in greater detail below, the aircraft hull attachment device 12 may include various features that 1) facilitate mounting the device 12 to the aircraft, 2) provide aerodynamic lift to the aircraft 14 during flight, and/or 3) otherwise enhance operation of the aircraft 14 once the device 12 is attached to the aircraft.

In certain embodiments, the mounting structure 16 of the device 12 defines a saddle wall 22 configured to nest about a belly of the aircraft's fuselage. The saddle wall 22 may facilitate mounting the device 12 to the aircraft 14 in a manner that evenly distributes operation loads (e.g., landing forces) between the device 12 and the aircraft 14 during operation.

In certain embodiments, the device's mounting structure 16 is configured to be attached to the fuselage of a large aircraft, such as a 5+ place aircraft, 10+ place aircraft, 30+ place aircraft, or even a 50+ place aircraft. As described below, the aircraft in some embodiments of this nature is a transport (e.g., commuter) aircraft. In the present embodiments, the device's mounting structure is thus configured to be (e.g., adapted for being) being mounted operatively to (e.g., so as to embrace) the large fuselage of such an aircraft. In some cases, the fuselage of such an aircraft has a diameter that is greater than 6 feet, such as between about 7 feet and about 10 feet. Such an aircraft may, for example, have a length of greater than 40 feet, such as between about 60 feet and about 80 feet. In such cases, the device 12 may have a saddle wall 22 with a concave contour having a radius of curvature RC (see FIG. 4) of greater than about 3 feet, such as between about 3.5 feet and about 5 feet. It is to be appreciated, however, that in its broadest aspects the present device 12 can be designed for attachment to a wide variety of small or large aircraft. Thus, the exemplary dimensions mentioned here are not limiting to the invention. The exemplary fuselage and saddle wall dimensions noted above can optionally be provided in any embodiment (i.e., with any disclosed combination of other features) of the present disclosure.

Additionally or alternatively, the device 12 can optionally include a water tank and a water drop door. The water tank can be used to transport and dispense water over a target area, such as a woodland fire. Device 12 may include additional features, as described below.

The aircraft hull attachment device 12 is configured to attach (e.g., mount) to the fuselage of an aircraft 14 to enable the aircraft to takeoff from and land on water. In general, the subject aircraft 14 may be any suitable type of aircraft including, e.g., a propeller-driven aircraft, a turboprop aircraft, or an aircraft with a jet engine. In certain preferred embodiments, the aircraft is one with fuselage-mounted landing gear. The aircraft 14 may have a single engine or a plurality of engines (e.g., two, three, or four engines).

In the example of FIGS. 1-3, the aircraft 14 is illustrated in the style of a transport aircraft (or “commuter aircraft”) that includes two wing-mounted engines (optionally turbine-powered propellers) and an elongated fuselage 20 that defines a substantially cylindrical or tube-like configuration. The aircraft 14 can, for example, be a medium range, twin-turboprop airliner. Some commercially manufactured aircraft that are suitable include, but are not limited to, the ATR 42 (or ATR 72) twin-turboprop airliner and the de Havilland DHC-8 twin-turboprop airliner (also known as the “de Havilland Canada Dash 8” or the “Bombardier Dash 8” or “Q-Series”).

The aircraft 14 in the examples of FIGS. 1-3 is a twin-engine (e.g., turbine powered) aircraft with an elongated fuselage having a substantially cylindrical or tube-like shape. The remainder of the present disclosure focuses on an example configuration for the device 12 where it is configured to mate with such an elongated, substantially cylindrical or tube-shaped fuselage. It should be appreciated, however, that the invention is not limited to any particular aircraft having any particular size, shape, configuration, or engine type.

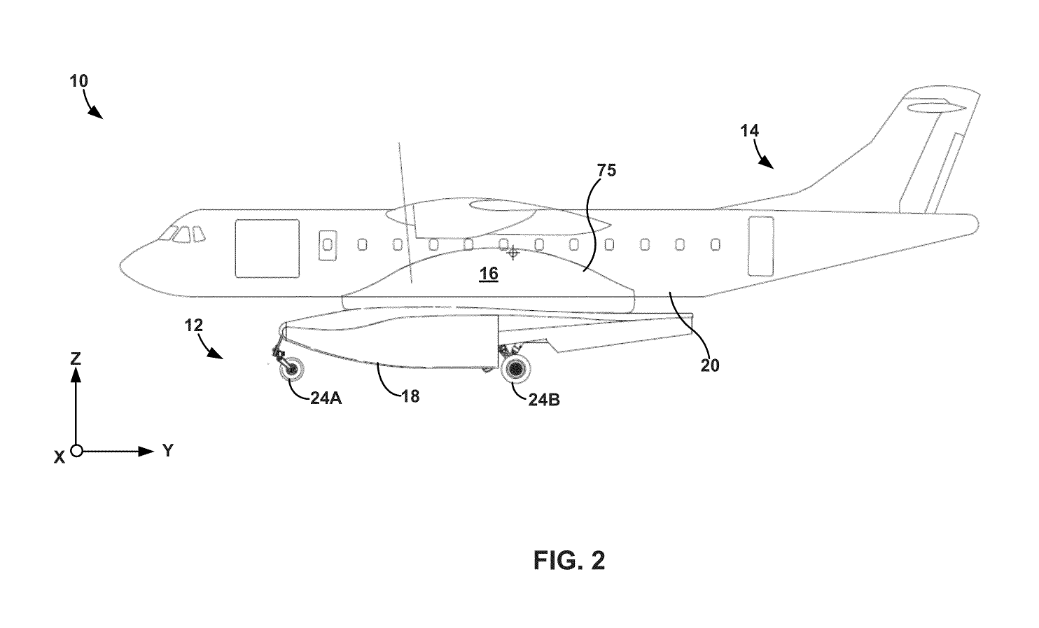

In the example of FIGS. 1-3, which depict an aircraft having an elongated, substantially cylindrical fuselage, the device 12 includes a mounting structure 16 that is configured (e.g., sized and shaped) to mate with an aircraft 14 such that the mounting structure is held adjacent to (e.g., embraces) a belly of the aircraft's fuselage 20. In the illustrated embodiment, the mounting structure 16 includes upwardly extending support walls 75 that are configured to be positioned adjacent to (e.g., carried against) opposing sidewalls of the aircraft's fuselage 20 so as to define a nest in which a belly region of the fuselage is received. In some embodiments, the support walls 75 of the mounting structure 16 extend upward so as to cover at least 10 percent of the vertical height of the sidewalls of the aircraft 14 (e.g., when measured in the Z-direction indicated on FIGS. 1 and 2) such as at least 25 percent of the vertical height, at least 33 percent of the vertical height, or at least 40 percent of the vertical height of the sidewalls of aircraft 14. These dimension ranges, however, are merely non-limiting examples. Increasing the height of the support walls can advantageously increase the mating surface area between the device 12 and the aircraft 14. This, in turn, can help distribute forces (e.g., landing forces) between the device 12 and the aircraft 14 during operation. In alternate embodiments, though, the mounting structure 16 of the device 12 may have no upwardly extending support walls (e.g., the mounting structure may attach exclusively to a bottom wall of an aircraft fuselage), or the support walls 75 may have a different size or shape than the example shown in FIGS. 1-3.

One example shape and structure for the aircraft hull attachment device 12 of FIGS. 1-3 is shown in greater detail in FIGS. 4-7, which are different perspective views of the device shown separated from the aircraft 14. Here, the mounting structure 16 of the device 12 defines a saddle wall 22 (FIG. 4) configured to be positioned adjacent to (e.g., mounted to) a belly of an aircraft fuselage (FIGS. 1-3). The illustrated saddle wall 22 defines a saddle shape, which may include two confronting regions 79 of higher elevation (e.g., in the Z-direction indicated on FIG. 4) separated by a region (e.g., a base region) 73 of comparatively lower elevation. The region of comparatively lower elevation 73 may define a nest (or cradle) into which a belly region of an aircraft fuselage may be positioned so as to couple the device 12 to the aircraft.

The saddle wall 22 in the embodiment of FIGS. 4-7 is shown as a single continuous wall (e.g., defining a generally semi-cylindrical surface against which the cylindrical fuselage 20 of the illustrated aircraft 14 can be mounted in a substantially flush manner). In other examples, however, the saddle wall 22 may be implemented using a plurality of walls (e.g., two, three, or more vertical walls separately extending from a common base of the device 12). Thus, it should be appreciated that the aircraft hull attachment device 12 is not limited to the example configuration of FIGS. 4-7.

As noted above, the aircraft hull attachment device 12 may be configured to be mounted about a belly of the aircraft's fuselage 20. For this reason, the device 12 may have a saddle wall 22 of a size and/or shape that corresponds to (or matches) the size and/or shape of the fuselage of the aircraft to which the device is intended to be mounted. Some exemplary, non-limiting dimensions were discussed earlier.

In some examples, the saddle wall 22 of the device 12 defines a base region 73 that is configured to be carried against (optionally flush against) a bottom region of the fuselage of the aircraft 14. In these examples, the saddle wall 22 may also define confronting side regions 79 extending upwardly from the base region 73 and being configured to be carried against (optionally flush against) opposing sidewalls of the aircraft's fuselage. In some embodiments, the entirety (or a substantial entirety) of the base region 73 and the confronting side regions 79 is mounted substantially flush against the aircraft's fuselage. This, however, is not required.

In cases where the device 12 is configured to be mounted to an aircraft having a substantially cylindrical fuselage, the saddle wall 22 may define a lesser portion of a cylinder, such as a generally or substantially semi-cylindrical saddle wall. An example of such a saddle wall is illustrated in FIGS. 4-7. Here, the saddle wall 22 defines a concave valley having a radius of curvature RC. Non-limiting, exemplary dimensions were discussed earlier. More generally, the saddle wall 22 can define any arcuate (e.g., circular, elliptical) or polygonal (e.g., square, hexagonal) shape, or even combinations of polygonal and arcuate shapes. The specific shape of the saddle wall 22 may vary, e.g., based on the specific shape of the aircraft to which device 12 is intended to be mounted. In some cases, the aircraft fuselage may be more “boxy,” e.g., having a more square or rectangular cross-sectional fuselage shape, rather than being circular or oval-shaped in cross section. In such cases, the saddle may have a more flat base region with confronting sidewalls that are more perpendicular to the base region.

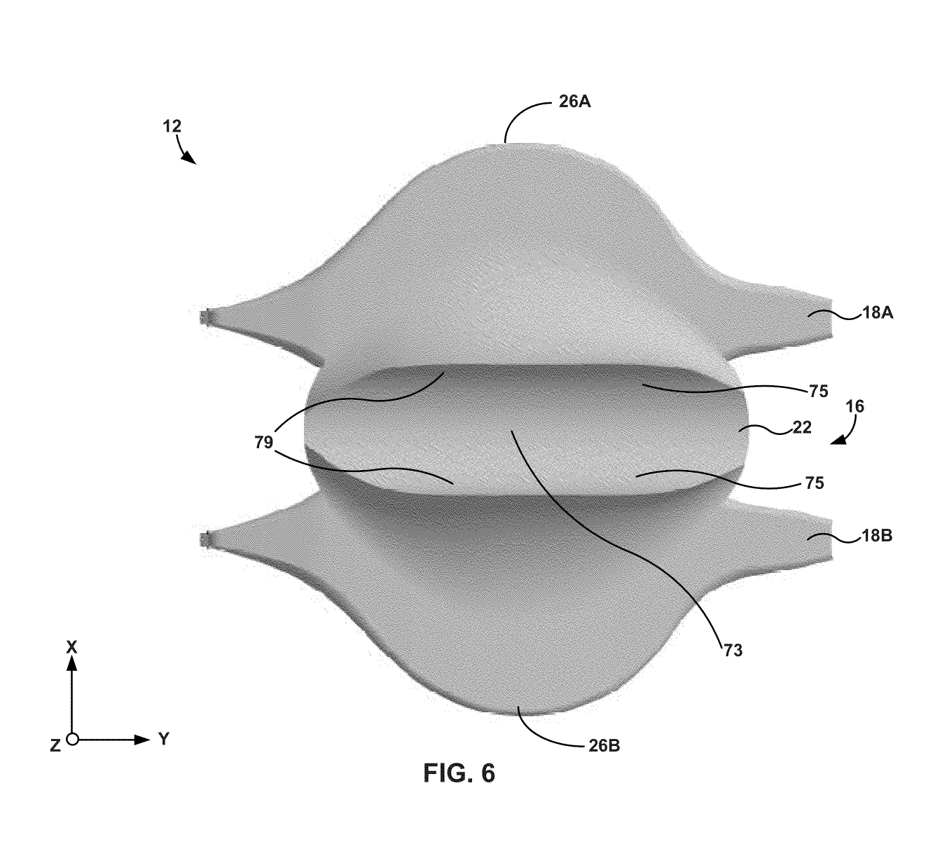

In the example of FIG. 4-7, the saddle wall 22 extends along substantially the entire length of the mounting structure 16 (i.e., in the Y-direction indicated on FIG. 6) so as to define an elongated valley (or “bed”) configured to receive a corresponding portion of a fuselage of an aircraft 14 (FIGS. 1-3). Increasing the surface area over which the device 12 contacts (e.g., is carried against) the aircraft 14 can increase the extent to which forces are distributed and/or dissipated over a larger area of the aircraft's fuselage. Such forces are, of course, generated during operation of the aircraft, including during takeoff and taxiing; the forces may be strongest during landing when force is transmitted through the device 12 to the fuselage of the aircraft 14. It can be advantageous to distribute such forces over a larger area so as to reduce metal fatigue and other wear over the service life of the device 12 and the aircraft 14. It can also minimize or eliminate the extent to which the airframe must be reinforced when mounting the device to the aircraft.

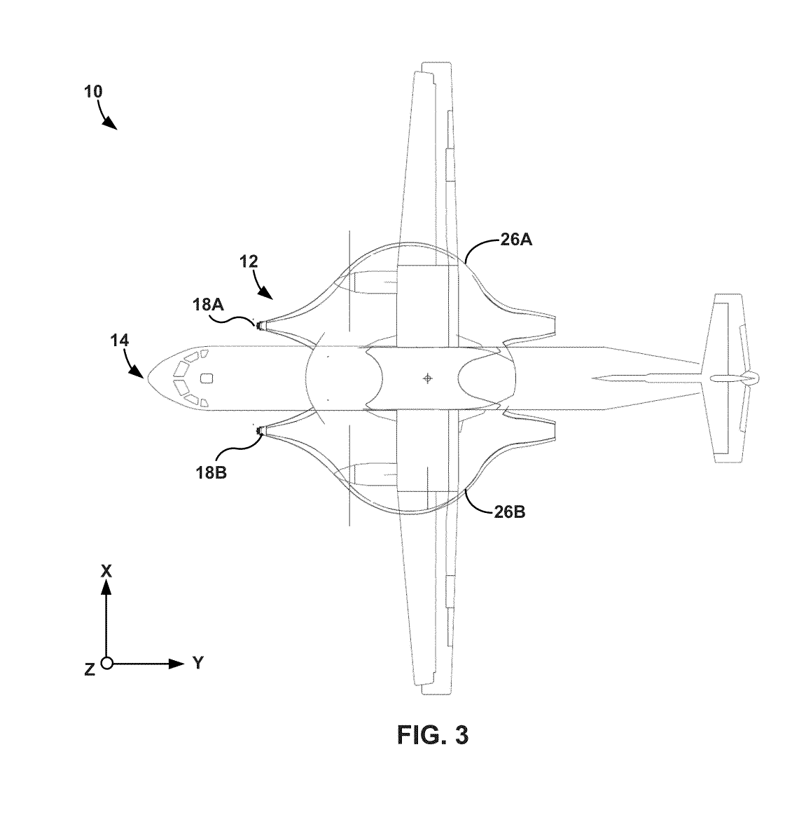

In some embodiments, the aircraft hull attachment device 12, or even just the saddle wall 22 of the device 12, is sized to extend along at least 1/10^{th}, at least ⅕^{th}, or at least a quarter of the length of the aircraft 14 (i.e., in the Y-direction indicated on FIGS. 2 and 3) when the device is mounted operatively on the aircraft. For example, the device may in some cases be sized to extend along at least a third of the length of the aircraft 14 when the device is mounted operatively on the aircraft, such as in the range of between approximately one-quarter to approximately one-half of the fuselage length. These relative dimensions, however, are not limiting to the invention. Rather, the length of the device 12 will depend upon the particular aircraft type used and other factors and design choices. Increasing the length of the saddle wall 22 relative to the length of the aircraft fuselage can help distribute, over a larger area, the loads that are transferred to the aircraft during operation.

Regardless of the specific shape of the device 12, the saddle wall 22 can optionally be configured to mate with the aircraft 14 (FIGS. 1-3) such that at least a portion of the wall 22 is carried against, and is substantially flush with, the fuselage of the aircraft 14. For example, the saddle wall 22 may be configured to mate with the aircraft 14 such that at least a portion of the saddle wall is in contact with a wall (e.g., a bottom wall region and/or sidewall regions) of the aircraft's fuselage. When so configured and assembled, at least a portion of the device 12 (and, optionally, substantially the entirety of the base 73 and confronting side regions 75 of the saddle wall 22) may be in flush, wall-to-wall contact with the fuselage of the aircraft 14.

When the aircraft hull attachment device 12 is mounted operably on the fuselage 20 of an aircraft 14 (FIGS. 1-3), the device 12 preferably covers (e.g., shrouds or conceals) a certain surface area of the fuselage. This covered surface area will be dictated by the size and shape of the saddle wall 22 relative to the size and shape of the aircraft's fuselage. Depending on the configuration of the aircraft hull attachment device 12, increasing the portion of the device (e.g., of a saddle wall 22 thereof) that is mounted flush to the fuselage can increase the area over which forces are transmitted between the device and the aircraft's fuselage during operation, thereby reducing the extent to which forces (e.g., operational loads) are concentrated on specific regions of the fuselage.

In various examples, the aircraft hull attachment device 12 is configured to be mounted against the aircraft fuselage such that the device (e.g., a saddle wall thereof) is flush against at least 20% of the fuselage surface area covered by the device, such as at least 30% of the covered surface area, at least 50% of the covered surface area, or at least 75% of the covered surface area. In some embodiments, the device 12 is configured to be mounted against the fuselage of an aircraft 14 such that the device (e.g., a saddle wall thereof) is flush against the fuselage over substantially the entirety of the covered surface area. Such is the case with the illustrated embodiment.

The aircraft hull attachment device 12 can be operatively mounted to an aircraft 14 using any suitable attachment system. In some cases, the device 12 is mounted to the aircraft 14 using one or more mechanical fasteners. As just one example, the device can be attached (e.g., using common aircraft hardware, such as rivets, bolts, Huck bolts, cherry rivets, adhesives, or sealants) through the bulkheads or stringers. Additionally, the attachment can gain integrity by bridging between the interface of the mating surfaces and the floor and seat rail structure of the aircraft.

In some embodiments, the device 12 is mounted to the aircraft 14 without adding any structural reinforcement to the fuselage. In such cases, the device 12 is configured to distribute force across the fuselage sufficiently well that airframe reinforcements are not required. Embodiments of this nature are particularly advantageous. In other embodiments, though, airframe reinforcement may be necessary or desirable.

The aircraft hull attachment device 12 preferably is mounted to the aircraft 14 such that the device is aligned with (e.g., located at) the aircraft's center of gravity (e.g., in the X-Y plane indicated on FIG. 3). In some embodiments, the device 12 is mounted on the aircraft such that the device's center of gravity is substantially aligned with (e.g., located at) the aircraft's center of gravity. In some embodiments, as is perhaps best seen in FIG. 3, the device 12 is mounted directly below the wings of the aircraft 14 (i.e., along the Y-axis indicated on FIGS. 2 and 3) so as to generally or substantially align the device's center of gravity with the aircraft's center of gravity. In other examples, the device 12 may be mounted so that the device's center of gravity is forward of the aircraft's main wings or rearward of those wings (i.e., in the Y-direction indicated on FIGS. 2 and 3).

Depending on the configuration of the device 12, the original landing gear on the aircraft 14 may be removed or retracted/disabled prior to attaching the device 12 to the aircraft. When the landing gear of the aircraft 14 is removed or retracted/disabled prior to attaching the device 12 to the aircraft (e.g., so that the original landing gear cannot be used for subsequent ground operation), the device 12 can optionally include auxiliary land gear (e.g., wheels, landing skids, etc) to facilitate ground operation. When provided, such landing gear preferably is part of an amphibious landing gear system, e.g., where a first set of retractable wheels is configured to extend from the first float 18A while a second set of retractable wheels is configured to extend from the second float 18B. In such cases, the wheels 24A, 24B preferably are selectively moveable between an extended configuration (so as to enable ground landing using the wheels) and a retracted configuration (so as to enable water landing using the floats).

In the example of FIGS. 4-7, the device 12 includes two forward wheels 24A and two rear sets of wheels 24B, with one forward wheel 24A arranged co-linearly with one rear set 24B of wheels along a major axis (e.g., a fore-aft axis) of float 18A and the other forward wheel arranged co-linearly with the other rear set of wheels along a major axis of float 18B. A different number or arrangement of wheels on the device 12 is also possible, as are embodiments where the device has no wheels (but instead has only the floats). Thus, in certain embodiments, the device 12 has a landing system including two floats and two sets of retractable wheels, such that when the device is mounted operably to an aircraft, the landing system renders the aircraft amphibious. A landing system of this type can be provided in any embodiment of the present disclosure, i.e., together with any combination of other features disclosed herein.

Thus, the device 12 includes at least one float for enabling the aircraft 14 to takeoff from and land on water. In the embodiments of FIGS. 4-7, the device has two floats 18. The device/float(s) 18 are configured to provide buoyancy sufficient to keep the aircraft 14 afloat when resting on a body of water. In certain embodiments, the device/float(s) are adapted (e.g., provide a buoyancy sufficient) to support (i.e., keep afloat on a body of water) an aircraft having a gross weight of greater than 10,000 pounds, greater than 15,000 pounds, greater than 20,000 pounds, or perhaps even greater than 50,000 pounds. In some embodiments, the device/float(s) are adapted to support an aircraft having a gross weight of between about 20,000 pounds and 200,000 pounds, such as between about 50,000 pounds and 200,000 pounds. These weight ranges are merely exemplary; the device can be adapted for use with lighter or heavier aircraft. In any embodiment of the present disclosure, the float(s) on the device 12 can optionally be capable of supporting an aircraft having a weight within the noted ranges.

In embodiments where the device 12 includes two floats 18, the floats when mounted operably to an aircraft can optionally have (e.g., provide) a 100% fresh water displacement of greater than 10,000 pounds, greater than 15,000 pounds, greater than 20,000 pounds, or perhaps even greater than 50,000 pounds. In some embodiments, the device's 100% fresh water displacement is between 20,000 pounds and 200,000 pounds, such as between about 50,000 pounds and 200,000 pounds. Again, these ranges are exemplary, non-limiting features. In any embodiment of the present disclosure, the device/float(s) can optionally have a 100% fresh water displacement within the noted ranges.

Preferably, each float defines one or more pockets filled with a material less dense than water such as, e.g., air, foam, or the like. The one or more pockets of material may be substantially sealed so as to isolate the low-density material from environmental elements such as water and sunlight. Other configurations of floats 18 are also possible.

Each float on the device 12 can optionally define an elongated keel (i.e., a fore-and-aft member), which extends along a length (i.e., along the Y axis) of the device. Thus, when the device includes two laterally-spaced apart floats/keels 18, those floats/keels preferably are substantially parallel to each other. In some embodiments, the length of each float/keel is greater than 10 feet, greater than 20 feet, or even greater than 25 feet, such as between about 25 feet and about 50 feet. These ranges are exemplary; they are not limiting to the invention. In any embodiment of the present disclosure, the float/keel length can optionally be within the any one or more of the noted ranges.

In the example of FIGS. 4-7, the device 12 includes two side-by-side, laterally spaced-apart floats 18. When so arranged, a centerline of float 18A (i.e., extending in the Y-direction indicated on FIG. 6) may be separated from a centerline of float 18B by a distance greater than the width (or diameter) of the airplane fuselage to which the device 12 is to be attached. This can be seen in FIG. 1. This arrangement can optionally be provided in any embodiment of the present disclosure, i.e., together with any combination of other features disclosed herein. In other cases, the floats 18A and 18B may be closer together or farther apart, or the device 12 may have a different number or different configuration of floats 18. Thus, it should be appreciated that the present disclosure is not limited to the particular number or configuration of floats shown in FIGS. 1-7.

The floats 18 may have any suitable shape. The illustrated floats 18 are each elongated in a direction parallel to the long dimension of the fuselage (e.g., in the fore-aft direction) to which the device is to be mounted. In the example of FIGS. 4-7, each float defines a V-hull shape (e.g., in the X-Z plane indicated on FIG. 4). The V-hull shape may define an apex (at a bottom of the float) that widens upwardly in a generally triangular shape so as to define an upper region that is wider than the apex. This type of shape may be hydrodynamically efficient when operating on water, helping to provide smooth and efficient water operations for the aircraft 14. Other float shapes are both possible and contemplated.

In some cases, when an aircraft is configured for water operation, the features that support water operation may negatively impact certain aerodynamic characteristics of the aircraft during flight. For example, floats on an aircraft may create hydrodynamic drag that can reduce the aerodynamic efficiency of the aircraft during flight. This may reduce the performance of the aircraft in some respects as compared to when the aircraft is not equipped for water operation.

Thus, in some embodiments, the present aircraft hull attachment device 12 includes one or more features that help compensate for any aerodynamic efficiency loss associated with attaching the device to the aircraft 14. For example, the device 12 can be configured (e.g., sized and shaped) such that it serves as a lifting body providing upward lift to the aircraft 14 during flight. Such a lifting body may reduce the stall speed of the aircraft 14, and/or reduce stress on the main wings of the airplane (compared to when the device 12 is not attached to the aircraft).

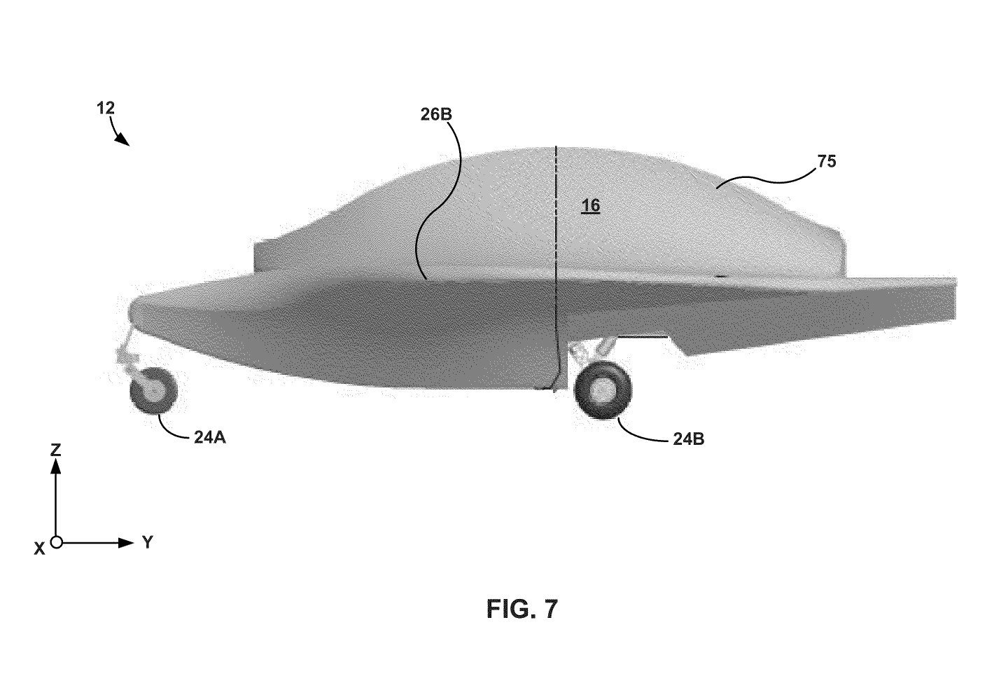

In the example of FIGS. 4-7, the aircraft hull attachment device 12 includes wings 26A and 26B (collectively “wings 26”), which can provide/contribute upward lift to the aircraft 14 during flight. Here, wing 26A extends outwardly from float 18A (i.e., in the X-direction indicated on FIG. 4) while wing 26B extends outwardly from float 18B. Other configurations are both possible and contemplated, of course. When provided, the wings 26 can optionally each define an aerofoil-shaped body that produces an aerodynamic lift force (e.g., generally or substantially perpendicular to the direction of aircraft motion) during operation. This is perhaps best appreciated with reference to FIG. 7.

When the aircraft hull attachment device 12 of FIGS. 4-7 is attached to an aircraft 14 (FIGS. 1-3), the wings 26 of the illustrated device 12 each have a shape that tapers in span (i.e., in the X-direction indicated on FIG. 3) toward a nose of the aircraft, tapers in span toward the tail of the aircraft, and increases in span (and reaches a maximum span) between the tapered front and tapered rear sections of the wing 26. Here, each wing of the device has an outwardly curved shape, e.g., a generally semi-circular shape (in the X-Y plane). Thus, the illustrated device includes two wings 26 extending outwardly in opposite directions respectively from two floats 18, and each illustrated wing has an outwardly convex wing configuration (in the X-Y plane). In other embodiments, each wing of the device may define a different arcuate (e.g., circular, elliptical) shape, or a polygonal (e.g., square, hexagonal) shape, or combinations of polygonal and arcuate shapes.

In some embodiments, the wings 26 of the device 12 each have a generally plate-shaped configuration characterized by each wing extending (e.g., in the X-direction) from one float 18 to a terminal wing tip region. More generally, the configuration of each wing 26 of the device 12 is preferably such that a width of the wing (e.g., in the Y-direction indicated on FIGS. 3 and 6) and a length or span of the wing (e.g., in the X-direction indicated on FIGS. 3 and 6) are each greater than a thickness of the wing (e.g., in the Z-direction indicated on FIGS. 2 and 7).

In the example of FIGS. 1-3, the wings 26 of the device 12 extend in a direction substantially parallel to wings of the aircraft 14 (i.e., in the X-Z plane indicated on FIG. 1). This is best seen in FIG. 1.

The specific dimensions of the device 12 and, in particular, of the wings 26 may vary, e.g., based on specific dimensions of the aircraft to which the device is to be attached. That being said, in some examples, the device 12 defines a major width (e.g., a width at the widest point across the device in the X-direction indicated on FIG. 6) that is between approximately 0.5 and approximately 1.5 times a major length of the device (e.g., a length at the longest point across the device in the Y-direction indicated on FIG. 6), such as a major width that ranges from approximately 0.75 to approximately 1.25 times the major length of the device, or a major width from 0.9 to 1.1 times the major length of the device. Here again, the noted dimension ranges are merely exemplary and non-limiting. The noted dimensions, however, can be provided in any embodiment of the present disclosure, i.e., together with any combination of other features disclosed herein.

The considerable width of the device 12 in the embodiments illustrated, and its substantial width-to-length ratio, can be advantageous in several respects. For example, this dimensioning can contribute to providing additional lift during flight. Additionally or alternatively, it can help keep water spray from the floats (during take-offs and landings) from reaching the propeller(s) and/or engine(s) of the aircraft. This is perhaps best appreciated by referring to FIG. 3.

While the specific dimensions of the device 12 can vary, in some examples, the device 12 has a major width of between about 20 feet and about 50 feet, such as between about 30 feet and about 50 feet. In such embodiments, the device 12 may have a major length of between about 40 feet and about 70 feet, such as between about 50 feet and about 70 feet. The dimensions noted here are merely examples; they are by no means limiting to the invention. These dimensions, however, can be provided in any embodiment of the present disclosure, i.e., together with any combination of other features disclosed herein.

The height of the device 12 will vary, of course, depending upon the particular aircraft to which the device is attached. In some exemplary embodiments, the device 12 has a height (i.e., in the Z-direction indicated on FIGS. 1 and 4) of between about 8 feet and about 14 feet, such as between about 10 feet and about 14 feet.

In some embodiments, the device's major length (which in the illustrated embodiment extends between the leading and trailing ends of the floats) can optionally be greater than 15%, greater than 30%, greater than 40%, or even greater than 45% of the length of the aircraft to which it is attached. For example, the ratio of the device's major length divided by the aircraft's length may be in the range of about 0.2 to 0.7, or 0.3 to 0.65, or 0.4 to 0.6. These dimensions and ratios, however, are merely non-limiting examples. The noted dimensions and ratios can be provided in any embodiment of the present disclosure, i.e., together with any combination of other features disclosed herein.

In addition to (or in lieu) of providing upward lift to the aircraft 14 during flight, the wings 26 of the device 12 can optionally serve other functions during operation of the aircraft 14. For instance, in applications where the device 12 is attached to a propeller-driven aircraft, the wings 26 of the device 12 can optionally be configured to help shield the propellers from water spray. Thus, in certain embodiments, the device 12 is mounted operably on an aircraft 14 having wing-mounted propellers, and the device is configured to prevent water (sprayed upwardly from the floats) from getting into the propellers. This is perhaps best appreciated by referring to FIGS. 2 and 3. Water spray can be generated by the floats 18 during takeoff and landing.

Additionally or alternatively, the wings 26 of the device 12 can optionally be configured to provide lateral stability to the aircraft 14 when operating on water. The wings 26 of the device 12, for example, can be configured to reduce lateral rocking or roll (e.g., in the X-direction indicated on FIG. 3) of the aircraft in the face of waves, wind, and the like. In some configurations, the wings 26 of the device 12 provide sufficient lateral stability that additional lateral stabilizers (e.g., floats mounted to the aircraft's main wings) need not be added to the aircraft to support water operations. Such additional lateral stabilizers may reduce the aerodynamic performance of the aircraft 14 during flight. In contrast to such additional lateral stabilizers, the device's wings 26 themselves can optionally define (e.g., function as) sponsons that provide lateral stability for the aircraft 14 when floating on water.

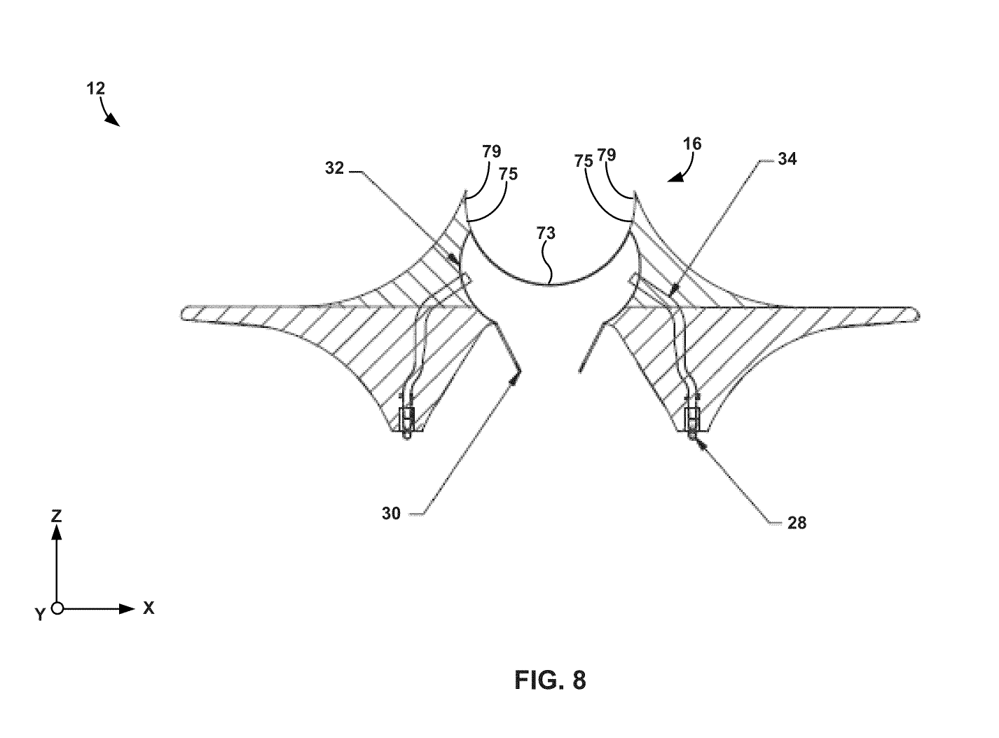

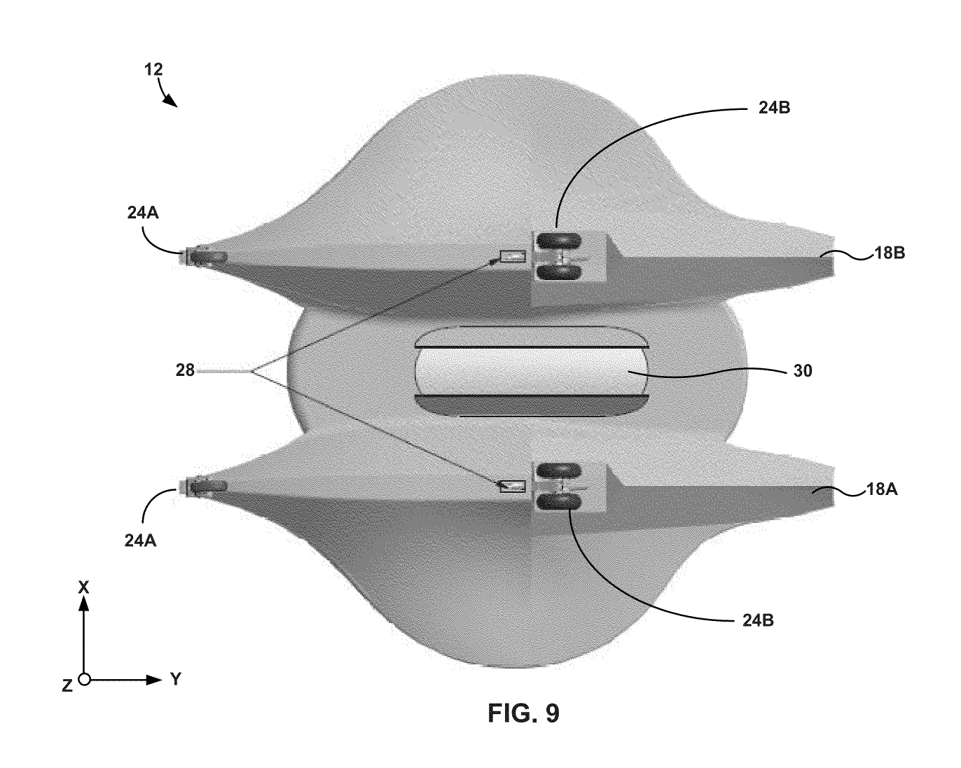

In certain embodiments, the aircraft hull attachment device 12 has an internal water tank 32. Reference is made to FIGS. 8 and 9. These figures illustrate one exemplary configuration wherein the aircraft hull attachment device 12 is configured for in-flight water drop operations. FIG. 8 is a cross-sectional view, and FIG. 9 is a bottom view, of an exemplary device 12 that includes the previously-described floats 18, wheels 24, and wings 26. In addition, in the example of FIGS. 8 and 9, the device 12 includes at least one optional water scoop (two water scoops 28 are shown), at least one water-drop door 30, at least one water tank 32, and an optional conduit 34. These features can optionally be provided in any embodiment of the present disclosure, i.e., together with any other combination of features disclosed herein.

In operation, the aircraft shown in FIGS. 8 and 9 can fill the water tank 32 of the device 12 via the water scoops 28 by touching down, flying just above (in a scooping run), or taxiing along a body of water. Water enters the water scoops 28 and is conveyed via conduits 34 into the water tank 32. Thereafter, the aircraft can fly to an intended target location, such as a woodland fire, and the operator can open the water-drop door 30 to drop water from the water tank 32 onto the target location. To facilitate controlled opening and closing of the water-drop door 30, the water-drop door can be operatively coupled (e.g., mechanically and/or electrically coupled) to an operator control station, such as a cockpit of the aircraft.

In the example of FIGS. 8 and 9, the device 12 includes a single water tank 32 that is located between the floats 18A and 18B. This location for the water tank 32 can be advantageous for aligning the water tank's center of gravity (e.g., when filled with water) with the aircraft's center of gravity. This can improve control and handling of the aircraft during flight as compared to if the water tank 32 were located at a different position. In the illustrated design, there is no water tank in either float. Rather, the water in the tank is located between the floats. If desired, though, part of the volume of such a central tank could be located in the floats. Additionally or alternatively, a plurality of water tanks can be located, at least in part, between the floats. Thus, in some embodiments, the water tank 32 is positioned at a location other than as illustrated in FIGS. 8 and 9, including in float 18A, in float 18B, or in both floats 18A and 18B. Separate water tanks (or connected water tank portions) could also be provided both in the floats and centrally between the floats, Thus, in certain embodiments, the device 12 includes more than one water tank 32, such as two, three, four, or more water tanks.

When provided, the (or each) water tank 32 can optionally define an enclosed cavity fluidly connected both to a scoop (or scoops) 28 and a water-drop door 30. These features can optionally be provided in any embodiment of the present disclosure, i.e., together with any combination of other features disclosed herein.

In the embodiment of FIGS. 8 and 9, the illustrated scoops 28 are configured to scoop water up from a body of water as the aircraft moves across the body of water (e.g., during a scooping run). Each illustrated scoop 28 is connected to a conduit 34 (see FIG. 8) so that each scoop is in fluid communication with the water tank 32. In the example of FIGS. 8 and 9, each scoop is located on the bottom of a float 18. However, other scoop locations are contemplated. For example, a single centerline mounted scoop can be provided between the floats.

To dispense water from the water tank 32 (e.g., onto a target location), the device 12 preferably includes a water-drop door 30. When provided, the water-drop door 30 is configured to retain the contents of the water tank 32 when closed and to release the contents of the water tank when opened. One example configuration of a water-drop door is a bombay door, which includes opposing hinged edges and is configured to separate about (e.g., open from) the middle of the door to release the contents of the water tank 32. Another example configuration of a suitable water-drop door is a door that includes a single hinged edge and is configured to open from one edge to release the contents of the water tank. Other water-drop door designs can be used as well.

In the example of FIGS. 8 and 9, the water-drop door 30 is located between the floats 18A and 18B and is spaced upwardly (i.e., in the Z dimension) from a water line of the device (i.e., when attached to an aircraft floating on water). When so arranged, the water-drop door 30 can be opened to drop the contents of the water tank 32 downwardly to the underlying water surface even when the floats 18 are floating on a body of water. Such an arrangement is useful for providing the ability to drop the contents of the water tank 32 without having to take to the air. This can be advantageous for safety purposes, since it enables the water-drop door to be operated during a scooping run for emergency purposes. In other examples, though, the water-drop door 30 may be at a location other than that illustrated in FIGS. 8 and 9, including on float 18A, on float 18B, or on both floats 18A and 18B. Thus, in some embodiments, the device 12 can have more than one water-drop door, e.g., two, three, four, or more water-drop doors.

The water tank 32 of the device 12 can be used to transport water or other material to a target location so as to aerially dispense the material over the location. In applications where the target location is a fire and the material to be dispensed is a fire retardant, the device 12 may be configured to receive a charge of fire retardant material and/or additive originating from inside the aircraft to which the device is attached. For example, the device 12 may include an aperture (or feed line) that is accessible from inside the aircraft and is in communication with the water tank 32. In such cases, a conduit extending through the fuselage of the aircraft may connect the aperture (or feed line) with the water tank 32. In this way, flame retardant materials or additives located within the fuselage of the aircraft may be supplied to the water tank 32 during operation so as to dispense the materials or additives over a target location.

With respect to the construction of the aircraft hull attachment device 12, it can be appreciated that a single (e.g., integral) device 12 preferably defines: 1) one or more floats, e.g., two-laterally spaced apart floats, and 2) a mounting structure 16 for attaching the device to an aircraft fuselage, optionally having a saddle-shaped mounting wall of the type described above. Optionally, the device 12 can further define two wings 26 of the nature described above. Additionally or alternatively, the same device 12 can have a water tank and a water-drop door, optionally with one or more water-scoops operably connected to the water tank. As seen in the illustrated embodiments, all of these features can advantageously be housed in and/or defined by a single housing structure (or “unit”). Thus, a single device 12, which houses and/or defines all these features, can advantageously be positioned against (e.g., on) the fuselage of an aircraft as a single unit (e.g., as a single part or piece). This, however, is not strictly required in all embodiments. Instead, the device could be designed to be mounted onto the aircraft fuselage in the form of two halves, or otherwise as multiple components.

The illustrated aircraft hull attachment can be manufactured in different ways. One non-limiting example will now be described. The device lends itself to a composite type of structure. Thus, suitable manufacturing methods include the design and manufacture of a “plug” to enable the manufacture of appropriate molds from which to form skins or outer surfaces of the structure. There may be need to form the structure in sections and eventually bond or fasten them together. With flat surface aircraft, it may be possible to make the structure from formed sheet metal, such as aluminum, titanium, or another aircraft metal. If the device is made of sheet metal, then the wings of the device would likely not have a generally semi-circular shape like that shown in the figures.

Various examples have been described. These and other examples are within the scope of the following claims.

1. An aircraft hull attachment device configured for attachment to a fuselage of an aircraft, the device having two laterally spaced-apart floats for enabling the aircraft to takeoff from and land on water, the device having a saddle wall configured to nest about a belly of the fuselage such that when the device is mounted operably on the fuselage a base region of the saddle wall is carried against a bottom region of the fuselage while confronting side regions of the saddle wall are carried against opposed sidewalls of the fuselage.

2. The aircraft hull attachment device of claim 1 wherein the saddle wall has a wall contour matching that of the fuselage belly such that when the device is mounted operably on the fuselage the saddle wall is in continuous wall-to-wall contact with the bottom region and the opposed sidewalls of the fuselage.

3. The aircraft hull attachment device of claim 2 wherein the saddle wall is configured to provide said continuous wall-to-wall contact such that during operation loads are not transferred to the aircraft in a concentrated pattern.

4. The aircraft hull attachment device of claim 1 wherein the saddle wall is a generally semi-cylindrical saddle wall.

5. The aircraft hull attachment device of claim 1 wherein when the device is mounted operably on the fuselage the device covers a certain surface area of the fuselage belly and the saddle wall is flush against the fuselage over at least 20% of said covered surface area.

6. The aircraft hull attachment device of claim 5 wherein the saddle wall is configured to be flush against the fuselage over at least 50% of said covered surface area.

7. The aircraft hull attachment device of claim 5 wherein the saddle wall is configured to be flush against the fuselage over substantially the entirety of said covered surface area.

8. The aircraft hull attachment device of claim 1 wherein the device is provided in combination with the aircraft.

9. The combination of claim 8 wherein the aircraft has a fuselage-mounted landing gear.

10. The combination of claim 8 wherein the aircraft is a prop-driven aircraft.

11. The combination of claim 8 wherein the aircraft is devoid of wing floats.

12. The aircraft hull attachment device of claim 1 wherein the device has a water tank and a water-drop door, the water-drop door being located between the two laterally spaced-apart floats.

13. The aircraft hull attachment device of claim 12 wherein the water-drop door is configured to drop water downwardly between the two floats.

14. The aircraft hull attachment device of claim 12 wherein when the device is mounted operably on the fuselage the water-drop door is located closer to the fuselage than are bottom surfaces of the two floats such that water from the tank can be dropped by the water-drop door even when the floats are floating on a body of water.

15. The aircraft hull attachment device of claim 8 wherein the device is configured such that it serves as a lifting body during flight and reduces a stall speed of the aircraft.

16. The aircraft hull attachment device of claim 1 wherein the device has two opposed wings extending outwardly away from the floats.

17. The aircraft hull attachment device of claim 16 wherein each wing of the device has a plate-shaped configuration and extends from one of the floats to a terminal wing-tip region.

18. The aircraft hull attachment device of claim 16 wherein when the device is mounted operably on the fuselage the wings of the device are substantially parallel to wings of the aircraft.

19. The aircraft hull attachment device of claim 10 wherein the device is configured to shield propellers of the aircraft from water spray from the floats during takeoff and landing.

20. The aircraft hull attachment device of claim 16 wherein the wings of the device extend outwardly from the floats so as to define sponsons that laterally stabilize the aircraft when floating on a body of water.

21. The aircraft hull attachment device of claim 17 wherein each wing of the device has a generally semi-circular shape.

22. The aircraft hull attachment device of claim 1 wherein each float has a set of retractable wheels configured to enable runway landings and takeoffs when the device is mounted operably on the fuselage.

23. An aircraft hull attachment device configured for attachment to a fuselage of an aircraft, the device having two laterally spaced-apart floats for enabling the aircraft to takeoff from and land on water, the device also having two opposed wings extending outwardly away from the floats, wherein when the device is mounted operably on the fuselage of the aircraft the wings of the device are substantially parallel to wings of the aircraft, the wings defining sponsons that laterally stabilize the aircraft when floating on a body of water, the device having a water tank and a water-drop door.

24. The aircraft hull attachment device of claim 23 wherein the water-drop door is located between the two floats of the device and is spaced upwardly from a water line of the device such that water from the tank can be dropped by the water-drop door even when the floats are floating on a body of water.

25. The aircraft hull attachment device of claim 23 wherein each wing of the device has a plate-shaped configuration and extends from one of the floats to a terminal wing-tip region.

26. The aircraft hull attachment device of claim 23 wherein each wing of the device has a generally semi-circular shape.

27. The aircraft hull attachment device of claim 23 wherein the water-drop door is a bombay door located between the two laterally spaced-apart floats.

28. The aircraft hull attachment device of claim 23 wherein each float has a set of retractable wheels configured to enable runway landings and takeoffs when the device is mounted operably on the fuselage.

29. The aircraft hull attachment device of claim 23 wherein the device has a saddle wall configured to nest about a belly of the fuselage such that when the device is mounted operably on the fuselage a base region of the saddle wall bears against a bottom region of the fuselage while confronting side regions of the saddle wall bear against opposed sidewalls of the fuselage, wherein the device when mounted operably on the fuselage covers a certain surface area of the fuselage belly such that the saddle defines a saddle wall that is flush against the fuselage over at least 50% of said covered surface area.

30. The aircraft hull attachment of claim 23 wherein the device has a saddle configured to nest about a belly of the fuselage, wherein a continuous generally semi-cylindrical wall defines a base region and confronting side regions of the saddle.

31. The aircraft hull attachment of claim 23 wherein the device is configured such that it serves as a lifting body during flight and reduces a stall speed of the aircraft.

32. The aircraft hull attachment of claim 23 wherein the device is provided in combination with the aircraft, the aircraft is a prop-driven aircraft having at least two propellers, and the device is configured to shield the propellers of the aircraft from water spray from the floats during takeoff and landing.
